(19) United States
(12) Patent Application Publication
(10) Pub. No.: US 2004/0110043 A1
(43) Pub. Date: Jun. 10, 2004

(54) Handpowered generating system combining capacitors and rechargeable batteries that can be applied to military and emergency equipment to provide a portable power supply

(76) Inventor: Alexander Charles Balazs, Grapevine, TX (US)

Correspondence Address: ALEXANDER C. BALAZS, U.S. EMBASSY THE HAGUE, PSC 71 BOX 20, APO, AE, 09715, US

(21) Appl. No.: 10/270,385

(22) Filed: Dec. 10, 2002

(51) Int. Cl. H01M 10/46

(52) U.S. Cl. 429/7; 320/112

(57) ABSTRACT

The new technical initiative of this invention is the combination of high power capacitors, rechargeable batteries, and a hand-powered generator that is portable. The addition of capacitors allows for a higher output of power, and a greater number of charges and discharges than all current rechargeable batteries. Additionally, it is a new combination in that capacitors do not demonstrate the same memory or limited life as rechargeable batteries. The combination is new in that current systems do not employ hand generator rechargeable capacitors to provide high power level in support of a rechargeable battery. The size of the power unit that uses this application will allow for greater application of portable, rechargeable power where standard power sources are unavailable.

This explanation is part of the Patent Application for an Hand Powered Generating System combining capacitors and rechargeable batteries.

The system will be applied to military backpack radios and heat generators for field use. The system will fit inside a standard field radio battery box and use the current spring wound gear reduction generator used in hand powered radios.

The generator unit will be cushioned and mounted inside the battery box with a main shaft that will pass through the side of the battery box. A waterproof seal will be placed on the shaft where it passes through the side of the battery box. The shaft will terminate in a coupling that will allow the crank handle to be removed or folded flat into a depression in the side of the battery box to prevent damage to the handle and shaft.

The generator will be connected to a rechargeable battery and a set of capacitors that will be controlled by a circuit to allow for the capacitors to remain isolated once charged. The system will allow for the battery to run the unit at low power and the capacitors to provide up to 20 watts for short periods of time.

The system will provide a rechargeable system for field use that weighs less than current systems, fits is a smaller package, provide higher powers requirements without affecting the life of the system and will not require additional charging units to be deployed to the field.

The unit will be fitted with a connector that will allow for it to be used with a portable heating unit as well as a portable radio.

This explanation is part of the Patent Application for a Hand Powered Generating System combining capacitors and rechargeable batteries.

1. What I claim as my invention is the use of capacitors in conjunction with a standard rechargeable or other battery unit. I claim as my invention the use of a hand-powered generating system to charge capacitors in conjunction with standard rechargeable batteries. Further, I claim as my invention the use of multiple in line capacitors placed in conjunction with a standard rechargeable battery unit that will allow for the overall unit to provide variable levels of powers without limiting the use of the high power setting. The capacitors, or the rechargeable battery, or the overall unit may provide the power as required to be managed by a standard control circuit. I claim also as my invention the use of a hand powered generating system to charge capacitors whether in conjunction with batteries or alone. I claim as my invention the application of a hand powered, rechargeable capacitor/battery source to communications devices and heating units.
The system may be applied to military backpack radios and heat generators for field use. The system will fit inside a standard field radio battery box or other portable power supply and use the currently available spring wound gear reduction generator used in hand powered radios.
For example, the generator unit will be cushioned and mounted inside the battery box with a main shaft that will pass through the side of the battery box. A waterproof seal will be placed on the shaft where it passes through the side of the battery box. The shaft will terminate in a coupling that will allow for the crank handle to be removed or folded flat into a depression in the side of the battery box to prevent damage to the handle and shaft. The handle connection to the shaft should be made from a soft alloy that will degrade more quickly than the shaft it attaches to.
The generator will be connected to a standard (this may be any of the rechargeable batteries dependent upon power draw and size requirements) rechargeable battery and a set of capacitors that will be controlled by a circuit to allow for the capacitors to remain isolated once charged to prevent overcharging. The system will allow for the battery to run the unit at low power and the capacitors to provide 20+ watts for short periods of time. A control unit will allow for the capacitors and the rechargeable battery to work together to provide constant levels of power as required by the device.
The system will provide a rechargeable system for field use that weighs less that current systems, fits in a smaller package, provide higher power for longer periods without affecting the life of the system. This system will reduce the need to deploy additional rechargeable units to the field, as the life of the system will be significantly increased.
The unit will be fitted with a connector to allow it to be used with a portable heating unit as well as a portable radio.
